(19) United States
(12) Patent Application Publication
(10) Pub. No.: US 2022/0139304 A1
(43) Pub. Date: May 5, 2022

(54) LIGHT EMITTING DEVICE AND LIGHT EMITTING UNIT

(71) Applicant: Innolux Corporation, Miao-Li County (TW)

(72) Inventors: Chin-Lung Ting, Miao-Li County (TW); Ming Chun Tseng, Miao-Li County (TW); Min-Hsin Lo, Miao-Li County (TW); Hung Sheng Liao, Miao-Li County (TW)

(73) Assignee: Innolux Corporation, Miao-Li County (TW)

(21) Appl. No.: 17/496,739

(22) Filed: Oct. 7, 2021

Related U.S. Application Data
(60) Provisional application No. 63/108,448, filed on Nov. 2, 2020.

(30) Foreign Application Priority Data
Jun. 11, 2021 (CN) 202110655763.X

(51) Int. Cl. G09G 3/32

(52) U.S. Cl. CPC G09G 3/32; G09G 2300/0452; G09G 2310/08; G09G 2310/0267

(57) ABSTRACT

The disclosure provides a light emitting device and a light emitting unit. The light emitting device includes a carrier, a first light emitting unit, and a second light emitting unit. The first light emitting unit is disposed on the carrier and has a first scan circuit, a first emit circuit, a first input terminal, and a first output terminal. The second light emitting unit is disposed on the carrier and has a second input terminal. The second input terminal is electrically connected to the first output terminal of the first light emitting unit. The first scan circuit is configured to provide a first scan signal to the first emit circuit and the second light emitting unit. The light emitting device and the light emitting unit of the disclosure may reduce the number of signal lines or have a circuit simplification effect.

### CROSS-REFERENCE TO RELATED APPLICATION

This application claims the priority benefits of U.S. provisional application Ser. No. 63/108,448, filed on Nov. 2, 2020, and Chinese application serial no. 202110655763.X, filed on Jun. 11, 2021. The entirety of each of the above-mentioned patent applications is hereby incorporated by reference herein and made a part of this specification.

### BACKGROUND

### Technical Field

The disclosure relates to a device, in particular to a light emitting device having a light emitting unit and a light emitting unit.

### Description of Related Art

For the light emitting diode (LED) unit in the current light emitting device, the pixel circuit and the gate driver on panel circuit are disposed separately on the carrier. Since the gate driving circuit is non-transparent and is disposed in the peripheral area of the carrier or next to the corresponding pixel circuit, configuration including too many gate driving circuits and lines will result in wasted carrier space and reduced light emitting area. Moreover, the number of signals on the carrier of the light emitting device is too large, and it is also prone to the risk of mutual coupling between signals.

### SUMMARY

The disclosure provides a light emitting device and a light emitting unit. The light emitting device includes a carrier, a first light emitting unit, and a second light emitting unit. The first light emitting unit is disposed on the carrier and has a first scan circuit, a first emit circuit, a first input terminal, and a first output terminal. The second light emitting unit is disposed on the carrier and has a second input terminal. The second input terminal is electrically connected to the first output terminal of the first light emitting unit. The first scan circuit is configured to provide a first scan signal to the first emit circuit and the second light emitting unit.

Based on the above, the light emitting device and the light emitting unit of the disclosure may reduce the number of signal lines or have a circuit simplification effect.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a light emitting device according to a first embodiment of the disclosure.

FIG. 2 is a schematic circuit diagram of a light emitting unit according to the first embodiment of the disclosure.

FIG. 3 is a schematic circuit diagram of a pixel circuit according to the first embodiment of the disclosure.

FIG. 4 is a schematic circuit diagram of an emit circuit according to the first embodiment of the disclosure.

FIG. 5 is a schematic circuit diagram of a gate driving circuit according to the first embodiment of the disclosure.

FIG. 6 is a partial line configuration diagram of the light emitting device according to the first embodiment of the disclosure.

FIG. 7A is a schematic circuit diagram of a light emitting unit according to a second embodiment of the disclosure.

FIG. 7B is a schematic circuit diagram of a light emitting unit according to a third embodiment of the disclosure.

FIG. 7C is a schematic circuit diagram of a light emitting unit according to a fourth embodiment of the disclosure.

FIG. 8 is a schematic circuit diagram of a light emitting device according to the third embodiment of the disclosure.

### DESCRIPTION OF THE EMBODIMENTS

Reference will now be made in detail to exemplary embodiments of the disclosure, examples of which are illustrated in the accompanying drawings. Wherever possible, the same reference numerals are used in the drawings and the description to refer to the same or like parts.

Throughout the description and the appended claims, certain terms are used to refer to specific elements. Those skilled in the art should understand that electronic devices manufacturers may refer to the same component by different terms. The present specification does not intend to distinguish between components that differ in name but not function. In the following description and the claims, terms such as “include” and “comprise” are open-ended, and therefore should be interpreted as “include but not limited to.”

In some embodiments of the disclosure, terms such as “joint”, “interconnection”, etc., unless specifically defined, may refer to two structures in direct contact, or may refer to two structures that are not in direct contact and in which other structures are provided between the two structures. The terms about connecting and joint may also include the case where both structures are movable, or where both structures are fixed. In addition, the terms “electrical connected” and “coupling” include any direct and indirect electrical connection.

The use of ordinal numbers such as “first”, “second”, and other terms used in the specification and claims to modify the elements does not in itself imply and represent that the, or those, elements have any previous ordinal numbers, nor does it represent the order of a element and another group of elements, or the order of manufacturing methods. The use of these ordinal numbers is only used to enable a named element and another element with the same name can be clearly distinguished. The claims and the specification may not use the same terminology, according to which the first member in the specification may be the second member in the claims. It should be noted that the following embodiments can replace, reorganize, and mix the technical features from several different embodiments to complete other embodiments without departing from the spirit of the disclosure.

It should be noted that the following embodiments may be used to replace, reorganize, or mix features from several different embodiments to complete other embodiments without departing from the spirit of the disclosure. The features of each embodiment can be mixed and matched as long as they do not contradict the spirit of the disclosure or conflict with each other.

The light emitting device disclosed in the disclosure may include a display device, an antenna device, a sensing device, a touch display, a curved display device, or a free shape display, but is not limited thereto. The light emitting device can be a bendable or flexible display device. The light emitting device may include, for example, liquid crystal, light emitting diode (LED), quantum dot (QD), fluorescence, phosphor, other suitable materials, or a combination of the foregoing, but is not limited thereto. The light emitting diodes may include, for example, organic light emitting diodes (OLED), Mini LED, Micro LED or quantum dot light emitting diodes (QLED or QDLED) or other suitable materials or any combination of the foregoing, but is not limited thereto. The light emitting device may include, for example, a spliced light emitting device, but is not limited thereto. The antenna device which may emit electromagnetic signals may be, for example, a liquid crystal antenna, but is not limited thereto. The antenna device may include, for example, a tiled antenna device, but is not limited thereto. It should be noted that the light emitting device can be any combination of the aforementioned arrangements, but is not limited thereto. In addition, the shape of the light emitting device can be rectangular, round, polygonal, with curved edges of the shape or other suitable shape. The light emitting device may have peripheral systems such as driving system, control system, light source system, and shelf system to support the display device, antenna device or spliced device. In addition, the substrate and the carrier according to each embodiment of the disclosure may be a circuit substrate, a glass substrate of a display panel, a flexible substrate, or the like.

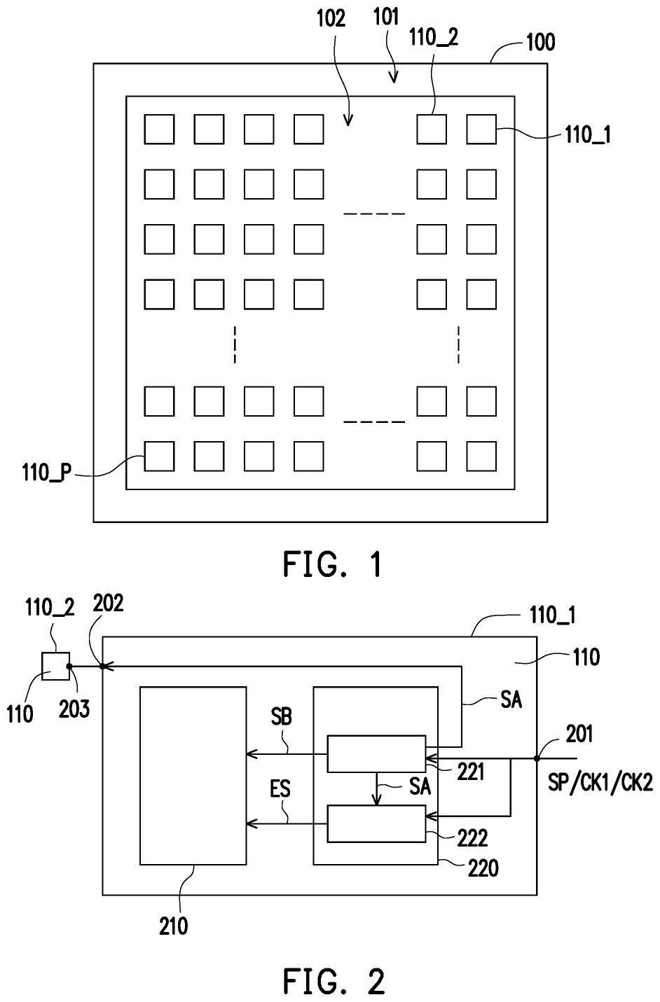

FIG. 1 is a schematic diagram of a light emitting device according to a first embodiment of the disclosure. Referring to FIG. 1, a light emitting device 100 includes multiple light emitting units 110_1 to 110_P disposed in an array in an active area (AA) 102 of a carrier 101, where P is a positive integer. The light emitting device 100 may be a transparent display device, but is not limited thereto. In this embodiment, at least a part of the light emitting units 110_1 to 110_P may individually integrate a gate driver on panel (GOP) circuit and a pixel circuit. Other areas of the carrier 101 except for the active area 102 are called peripheral areas. In this embodiment, the light emitting device 100 may be in a form of the light emitting diode as described above, such as an Active Matrix Mini LED (AM-Mini LED) display device, and the carrier 101 may be a transparent glass carrier, but the disclosure is not limited thereto. In this embodiment, since the light emitting units 110_1 to 110_P may respectively integrate a gate driving circuit and the pixel circuit, and the gate driving circuit and the pixel circuit may receive a same start pulse and a same clock signal, the light emitting device 100 may reduce number of signal lines or space occupied by the gate driver circuit on the carrier 101, and has a circuit simplification effect.

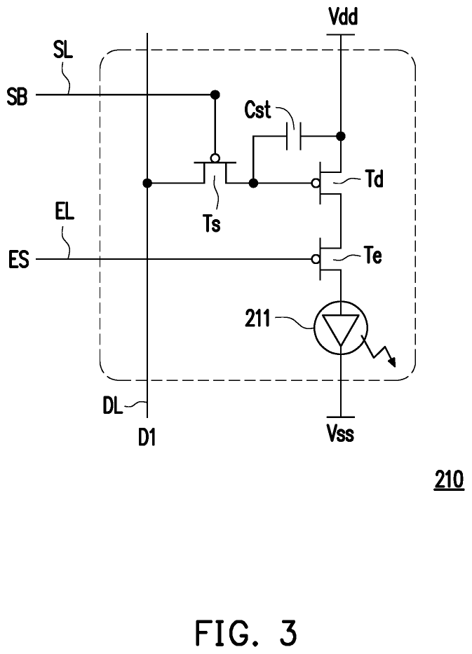

FIG. 2 is a schematic circuit diagram of a light emitting unit according to the first embodiment of the disclosure. Referring to FIG. 1 and FIG. 2, the light emitting unit 110_1 and the light emitting unit 110_2 are taken as examples in the following description. The light emitting unit 110_1 includes a substrate 110, an input terminal 201, an output terminal 202, a pixel circuit 210, and a gate driving circuit 220. The gate driving circuit 220 includes a scan circuit 221 and an emit circuit 222. The pixel circuit 210, the scan circuit 221, and the emit circuit 222 may be disposed on the substrate 110. The light emitting unit 110_2 includes an input terminal 203. The substrate 110 may be located on the carrier 101. More specifically, the substrate 110 of the light emitting unit 110_1 may have lines (not shown). Through the lines on the substrate 110, the scan circuit 221 may be electrically connected to the pixel circuit 210 and the emit circuit 222. The carrier 101 of the light emitting device 100 also has lines (not shown). The substrate 110 of the light emitting unit 110_1 may be electrically connected to the carrier 101, and through the lines on the carrier 101, the scan circuit 221 may be electrically connected to the light emitting unit 110_2. The emit circuit 222 is electrically connected to the pixel circuit 210 and the scan circuit 221. The input terminal 203 of the light emitting unit 110_2 is electrically connected to the output terminal 202 of the light emitting unit 110_1. In this embodiment, the scan circuit 221 and the emit circuit 222 may receive a same start pulse SP, a clock signal CK1, and a clock signal CK2 from the input terminal 201. The clock signal CK2 may be an inverted signal of the clock signal CK1, but the disclosure is not limited thereto. In this embodiment, the start pulse SP may be provided by a scan circuit of a previous stage light emitting unit of the light emitting unit 110_1, or provided by a driving circuit disposed in a peripheral area of the substrate 101. The scan circuit 221 may provide a second scan signal SB to the pixel circuit 210 for driving internal circuit elements of the pixel circuit 210. In this embodiment, the emit circuit 222 may generate an emit signal ES according to the start pulse SP, the clock signal CK1, the clock signal CK2, and a first scan signal SA provided by the scan circuit 221, and provide the emit signal ES to the pixel circuit 210 to drive the pixel circuit 210. Similarly, the input terminal 203 of the light emitting unit 110_2 may receive the first scan signal SA, the clock signal CK1, and the clock signal CK2 from the light emitting unit 110_1. In this regard, the light emitting units of any two adjacent stages of the light emitting units 110_1 to 110_P in FIG. 1 may be configured as shown in FIG. 2. In this way, the light emitting device 100 may reduce the number of signal lines or reduce circuit complexity. It should be noted that although in FIG. 2, the pixel circuit 210, the scan circuit 221, and the emit circuit 222 of the light emitting unit 110_1 are all disposed on the substrate 110, the substrate 110 is then electrically connected to the carrier 101. However, in some embodiments, the pixel circuit 210, the scan circuit 221, and the emit circuit 222 of the light emitting unit 110_1 may be directly disposed on the carrier 101 in a small area. That is to say, the light emitting unit 110_1 may be formed directly on the carrier 101.

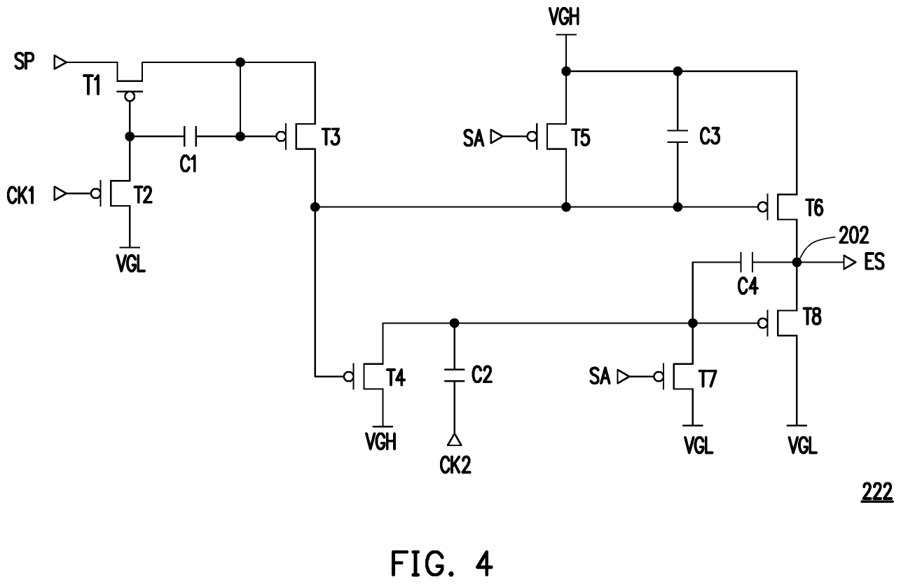

FIG. 3 is a schematic circuit diagram of a pixel circuit according to the first embodiment of the disclosure. Referring to FIG. 2 and FIG. 3, specific implementation of the pixel circuit of the disclosure may be, for example, but not limited to, the pixel circuit 210 shown in FIG. 3. In this embodiment, the pixel circuit 210 includes transistors Ts, Td, Te, a storage capacitor Cst, and a light emitting diode 211. The transistors Ts, Td, and Te may be P-type transistors, respectively, but in some embodiments, the transistors may be changed in part or in whole to N-type transistors. The light emitting diode 211 may be (but is not limited to) in a form of the light emitting diode as described above, such as a Mini LED. In this embodiment, a first terminal of the transistor Ts is electrically connected to a data line DL, and a second terminal of the transistor Ts is electrically connected to a control terminal of the transistor Td and a first terminal of the storage capacitor Cst. A control terminal of the transistor Ts is electrically connected to a scan signal line SL. A first terminal of the transistor Td is electrically connected to a second terminal of the storage capacitor Cst and a voltage Vdd. A second terminal of the transistor Td is electrically connected to a first terminal of the transistor Te. A control terminal of the transistor Te is electrically connected to an emit signal line EL. A second terminal of the transistor Te is electrically connected to one terminal of the light emitting diode 211. Another terminal of the light emitting diode 211 is electrically connected to a voltage Vss. In this embodiment, the scan signal line SL may receive the second scan signal SB. The emit signal line EL may receive the emit signal ES. The data line DL may receive a data signal D1. Therefore, the pixel circuit 210 may drive the light emitting diode 211 according to the second scan signal SB, the emit signal ES, and the data signal D1.

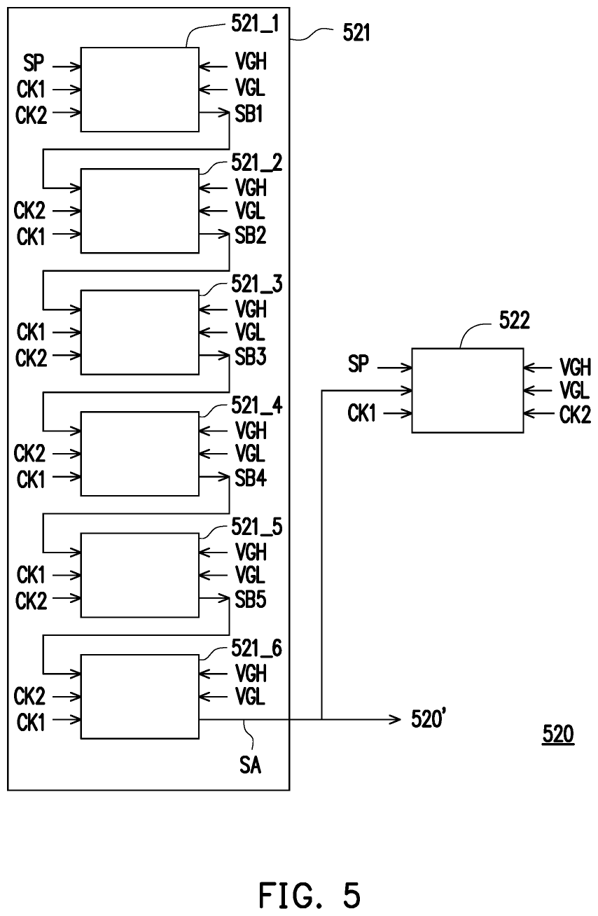

FIG. 4 is a schematic circuit diagram of an emit circuit according to the first embodiment of the disclosure. Referring to FIG. 2 and FIG. 4, specific implementation of the emit circuit of the disclosure may be, for example, but not limited to, the emit circuit 222 shown in FIG. 4. In this embodiment, the emit circuit 222 includes transistors T1 to T8 and capacitors C1 to C4. The transistors T1 to T8 may be P-type transistors, respectively. A first terminal of the transistor T1 may receive the start pulse SP. A second terminal of the transistor T1 is electrically connected to a first terminal and a control terminal of the transistor T3 and a first terminal of the capacitor C1. A control terminal of the transistor T1 is electrically connected to a first terminal of the transistor T2 and a second terminal of the capacitor C1. A control terminal of the transistor T2 may receive the first clock signal CK1. A second terminal of the transistor T2 is electrically connected to a voltage VGL. The control terminal of the transistor T3 is electrically connected to the first terminal of the capacitor C1 . A second terminal of the transistor T3 is electrically connected to a control terminal of the transistor T4, a first terminal of the transistor T5, a control terminal of the transistor T6, and a first terminal of the capacitor C3. A first terminal of the transistor T4 is electrically connected to a first terminal of the transistor T7, a control terminal of the transistor T8, a first terminal of the capacitor C2, and a first terminal of the capacitor C4. A second terminal of the capacitor C2 may receive the second clock signal CK2. A second terminal of the transistor T4 is electrically connected to a voltage VGH. A control terminal of the transistor T5 may receive the first scan signal SA. A second terminal of the transistor T5 is electrically connected to the voltage VGH, a second terminal of the capacitor C3 and a first terminal of the transistor T6. A second terminal of the transistor T6 is electrically connected to the output terminal 202, a first terminal of the transistor T8, and a second terminal of the capacitor C4. A control terminal of the transistor T7 may receive the first scan signal SA. A second terminal of the transistor T7 is electrically connected to the voltage VGL. A second terminal of the transistor T8 is electrically connected to the voltage VGL. Therefore, the emit circuit 222 may provide the emit signal ES from the output terminal 202 according to the start pulse SP, the first clock signal CK1, the second clock signal CK2, and the first scan signal SA.

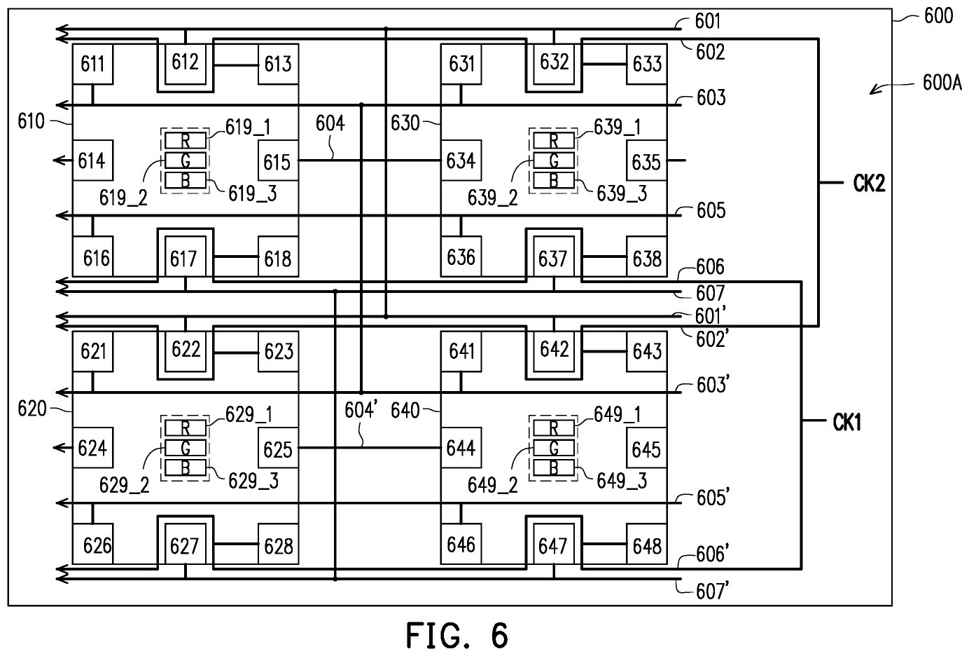

FIG. 5 is a schematic circuit diagram of a gate drive circuit according to the first embodiment of the disclosure. Referring to FIG. 5, specific implementation of the gate driving circuit of the disclosure may be, for example, but not limited to, a gate driving circuit 520 shown in FIG. 5. In this embodiment, the gate driving circuit 520 includes a scan circuit 521 and an emit circuit 522. The scan circuit 521 may include multiple scan units 521_1 to 521_6. The scan units 521_1 to 521_6 and the emit circuit 522 receive the same first clock signal CK1, second clock signal CK2, voltage VGH, and voltage VGL, respectively. In this embodiment, the scan unit 521_1 receives the start pulse SP, and outputs a second scan signal SB1 to a pixel circuit (for example, the pixel circuit 210 of FIG. 2) and a next stage scan unit 521_2 to serve as a start pulse of the scan unit 521_2. The scan unit 521_2 receives the second scan signal SB1, and outputs a second scan signal SB2 to a pixel circuit and a next stage scan unit 521_3 to serve as a start pulse of the scan unit 521_3. The scan unit 521_3 receives the second scan signal SB2, and outputs a second scan signal SB3 to a pixel circuit and a next stage scan unit 521_4 to serve as a start pulse of the scan unit 521_4. The scan unit 521_4 receives the second scan signal SB3, and outputs a second scan signal SB4 to a pixel circuit and a next stage scan unit 521_5 to serve as a start pulse of the scan unit 521_5. The scan unit 521_5 receives the second scan signal SB4, and outputs a second scan signal SB5 to a pixel circuit and a next stage scan unit 521_6 to serve as a start pulse of the scan unit 521_6. The scan unit 521_6 receives the second scan signal SB5, and outputs the first scan signal SA to the emit circuit 522 and a gate driving circuit of a next stage light emitting unit. In this regard, since the gate driving circuit 520 of this embodiment integrates the scan circuit 521 and the emit circuit 522, and the scan circuit 521 and the emit circuit 522 receive the same start pulse and clock signal, the gate driving circuit 520 according to this embodiment may reduce the number of signal lines, or reduce circuit complexity. In addition, number of the scan units of the scan circuit in the disclosure may be determined according to different signal requirements or circuit design, and is not limited to that shown in FIG. 5.

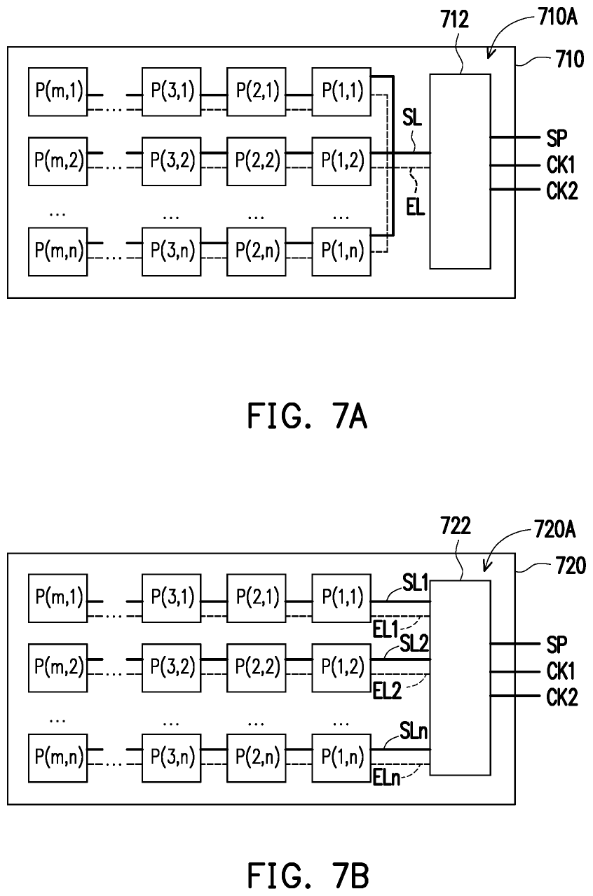

FIG. 6 is a partial line configuration diagram of the light emitting device according to the first embodiment of the disclosure. Each of the light emitting units 110_1 to 110_P in FIG. 1 may be in a form of an integrated chip as shown in FIG. 6. 2×2 arranged integrated chips 610, 620, 630, and 640 are taken as examples in a light emitting device 600 of this embodiment to illustrate a line configuration on a carrier 600A of the light emitting device 600. The integrated chip 610 may be a next stage of the integrated chip 630, the integrated chip 620 may be a next stage of the integrated chip 640, and the integrated chips 610, 620, 630, and 640 include the scan circuits and the emit circuits. Referring to FIG. 6, the integrated chip 610 includes pads (e.g., metal pads) 611 to 618 and light emitting diodes 619_1 to 619_3. The integrated chip 620 includes pads 621 to 628 and light emitting diodes 629_1 to 629_3. The integrated chip 630 includes pads 631 to 638 and light emitting diodes 639_1 to 639_3. The integrated chip 640 includes pads 641 to 648 and light emitting diodes 649_1 to 649_3. The light emitting diodes 619_1, 629_1, 639_1, and 649_1 may be red light emitting diodes, for example. The light emitting diodes 619_2, 629_2, 639_2, 649_2 may be green light emitting diodes, for example. The light emitting diodes 619_3, 629_3, 639_3, and 649_3 may be blue light emitting diodes, for example. In this embodiment, the pad 611 may be a first power pad. The pad 612 may be a second power pad. The pad 613 and the pad 618 may be configured to receive the first clock signal CK1 and the second clock signal CK2, respectively. The pad 614 may be a signal output pad. The pad 615 may be a signal input pad. The pad 616 may be a data input pad. The pad 617 may be a third power pad. 619_1 to 619_3, 629_1 to 629_3, 639_1 to 639_3, and 649_1 to 649_3 are respectively disposed in display areas of the integrated chips 610, 620, 630, and 640. It should be noted that number of pads included in each integrated chip, signal type corresponding to each pad, and color and number of the light emitting diodes are not limited to those described in FIG. 6 and the above text.

In this embodiment, lines 601 and 601′ are respectively electrically connected to a part of the pads 612, 622, 632, and 642 of the integrated chips 610, 620, 630, and 640, and lines 607 and 607′ are respectively electrically connected to a part of the pads 617, 627, 637, and 647 of the integrated chips 610, 620, 630, and 640. The lines 601 and 601′ may, for example, provide a low-voltage power signal, and the lines 607 and 607′ may, for example, provide a high-voltage power signal. As shown in FIG. 6, the lines 601, 601′, 607, and 607′ do not span the integrated chip 610 and the integrated chip 620, but are configured along peripheral areas of the integrated chips 610, 620, 630, and 640, respectively. In this embodiment, lines 602 and 602′ are respectively electrically connected to a part of the pads 613, 623, 633, and 643 of the integrated chips 610, 620, 630, 640. Lines 606 and 606′ are respectively electrically connected to a part of the pads 618, 628, 638, and 648 of the integrated chips 610, 620, 630, and 640. The lines 602 and 602′ may provide the second clock signal CK2, and the lines 606 and 606′ may provide the first clock signal CK1, for example. The lines 602, 602′, 606, and 606′ partially overlap the integrated chip 610 and a small portion of the integrated chip 620, respectively, while most of the lines 602, 602′, 606, and 606′are still configured along the peripheral areas of the integrated chips 610, 620, 630 and 640. In this embodiment, the lines 603 and 603′ are respectively electrically connected to a part of the pads 611, 621, 631, and 641 of the integrated chip 610, 620, 630 and 640, and lines 605, 605′ are respectively electrically connected to a part of the pads 616, 626, 636, and 646 of the integrated chips 610, 620, 630, and 640. The lines 603 and 603′ may, for example, provide another high-voltage power signal, and the lines 605 and 605′ may, for example, provide a data signal.

In this embodiment, line 604 is configured to electrically connect the signal input pad 615 of the integrated chip 610 and a signal output pad 634 of the adjacent integrated chip 630.

Line 604′ is configured to electrically connect a signal input pad 625 of the integrated chip 620 and a signal output pad 644 of the adjacent integrated chip 640, so that the integrated chips 610 and 620 use scan signals provided by the integrated chips 630 and 640 as start pulses to drive internal scan circuits of the integrated chips 610 and 620. In the same way, the pads 635 and 645 of the integrated chips 630 and 640 may respectively receive a previous stage scan signal (for example, a scan signal of a previous integrated chip in a same row, not shown), and the pads 614 and 624 of the integrated chips 610 and 620 may respectively output a scan signal to a next stage integrated chip (for example, a next integrated chip in a same row, not shown).

Therefore, in this embodiment, the lines 601 to 603, 605 to 607, 601′ to 603′, and 605′ to 607′ may be connected in series to multiple integrated chips in a row, and the lines 604 and 604′ are configured to electrically connect signal input pads and signal output pads between two adjacent integrated chips, respectively. In this regard, since scan signals of the integrated chips 610, 620, 630, and 640 of this embodiment are provided by corresponding previous stage integrated chips, there is no need to dispose an additional external scan signal line that may electrically connect all integrated chips in a same row, which may simplify circuit configuration on the carrier 600A or reduce space required for line configuration. In addition, since the lines 601 to 602, 604, 606 to 607, 601′ to 602′, 604′, and 606′ to 607′ may be configured along the peripheral areas of the integrated chips 610, 620, 630, and 640, when the light emitting device 600 of this embodiment is a transparent display device, the line configuration as shown in FIG. 6 may reduce areas occupied by the lines and improve overall transparency of the light emitting device 600.

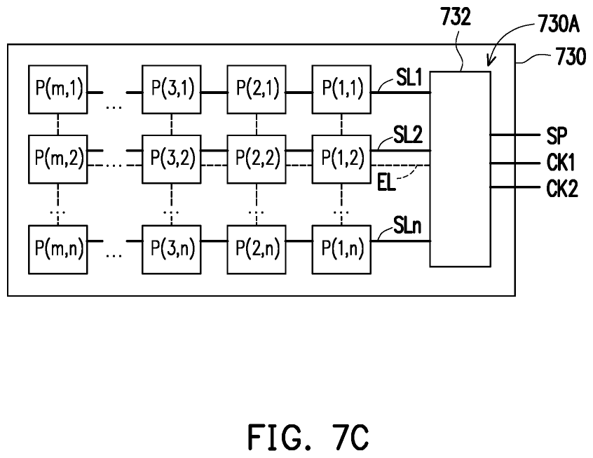

In the foregoing embodiments, one gate driving circuit corresponds to one pixel circuit, while FIG. 7A shows a schematic circuit diagram when one gate driving circuit corresponds to multiple pixel circuits according to the second embodiment of the disclosure. Referring to FIG. 7A, a light emitting unit 710 includes a substrate 710A, multiple pixel circuits P(1, 1) to P(m, n), and a gate driving circuit 712, where m and n are positive integers. In this embodiment, the gate driving circuit 712 may receive the start pulse SP, the first clock signal CK1, and the second clock signal CK2 provided by an external system circuit. The gate driving circuit 712 may generate a scan signal and an emit signal according to the start pulse SP, the first clock signal CK1, and the second clock signal CK2. The gate driving circuit 712 may be respectively electrically connected to the scan signal line SL and the emit signal line EL through two output interfaces, and provide a scan signal and an emit signal to multiple rows and multiple columns of the pixel circuits P(1, 1) to P(m, n). In this regard, since the gate driving circuit 712 is adopted in a one-to-many manner to drive the pixel circuits P(1, 1) to P(m, n), the light emitting device using the light emitting unit 710 of this embodiment may reduce total number of gate drive circuits or number of lines in the light emitting device.

FIG. 7B is a schematic circuit diagram of a light emitting unit according to a third embodiment of the disclosure. Similar to FIG. 7A, a light emitting unit 720 in FIG. 7B includes a substrate 720A, multiple pixel circuits P(1, 1) to P(m, n), and a gate driving circuit 722. In this embodiment, the gate driving circuit 722 may receive the start pulse SP, the first clock signal CK1, and the second clock signal CK2 provided by the external system circuit. However, unlike FIG. 7A, the gate driving circuit 722 may generate multiple scan signals and multiple emit signals according to the start pulse SP, the first clock signal CK1, and the second clock signal CK2. The gate driving circuit 722 may be respectively electrically connected to multiple scan signal lines SL1 to SLn and multiple emit signal lines ELI to ELn through multiple output interfaces (for example, plural scan signal output interfaces and plural emit signal output interfaces) to provide multiple scan signals and multiple emit signals to multiple rows and multiple columns of the pixel circuits P(1, 1) to P(m, n). In this regard, since the gate driving circuit 722 is adopted in a one-to-many manner to drive the pixel circuits P(1, 1) to P(m, n), the light emitting device using the light emitting unit 720 of this embodiment may reduce total number of gate drive circuits or number of lines in the light emitting device.

FIG. 7C is a schematic circuit diagram of a light emitting unit according to a fourth embodiment of the disclosure. Similar to FIG. 7A, a light emitting unit 730 in FIG. 7C includes a substrate 730A, multiple pixel circuits P(1, 1) to P(m, n), and a gate driving circuit 732. In this embodiment, the gate driving circuit 732 may receive the start pulse SP, the first clock signal CK1, and the second clock signal CK2 provided by the external system circuit. However, unlike FIG. 7A, the gate driving circuit 732 may generate multiple scan signals and one emit signal according to the start pulse SP, the first clock signal CK1, and the second clock signal CK2. The gate driving circuit 732 may be electrically connected to multiple scan signal lines SL1 to SLn and one emit signal line EL through plural scan signal output interfaces and one emit signal output interface, and provide multiple scan signals and one emit signal to multiple rows and multiple columns of the pixel circuits P(1, 1) to P(m, n). Any two pixel circuits in two adjacent rows may be electrically connected through additional lines to transmit the emit signal. In this regard, since the gate driving circuit 732 is adopted in a one-to-many manner to drive the pixel circuits P(1, 1) to P(m, n), the light emitting device using the light emitting unit 730 of this embodiment may reduce total number of gate drive circuits or number of lines in the light emitting device. It should be noted that the gate driving circuit 732 in the embodiment of FIG. 7C may also be changed to a circuit that can output one scan signal and multiple emit signals. It should be noted that in the embodiments of FIG. 7A to FIG. 7C, instead of having the pixel circuits in a same row electrically connected to a same signal line (e.g., a same scan signal line or a same emit signal line), two adjacent pixel circuits in the same row may be electrically connected by a shorter scan signal line and/or a shorter emit signal line, but this disclosure is not limited thereto. In some embodiments, the pixel circuits in a same row may be electrically connected to a same signal line.

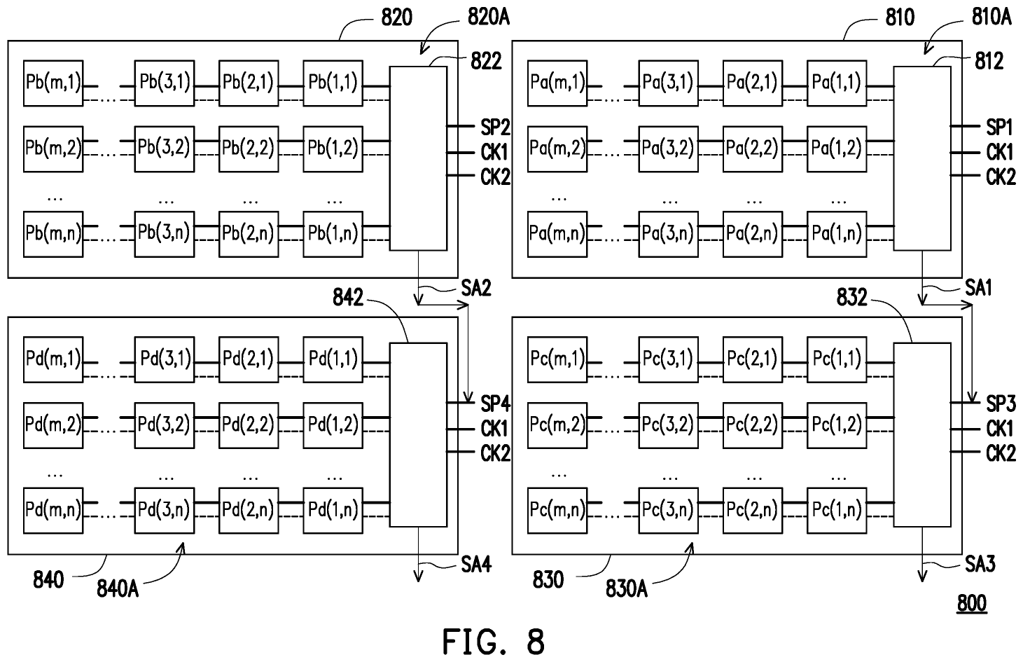

FIG. 8 is a schematic circuit diagram of a light emitting device according to the third embodiment of the disclosure. Referring to FIG. 8, a light emitting device 800 includes multiple light emitting units 810 to 840. In this embodiment, the light emitting device 800 may be, for example, a tiled display, and the light emitting units 810 to 840 are fixed within the light emitting device 800 by, for example, disposing multiple light emitting units 810 to 840 on a carrier (not shown). The light emitting unit 810 includes a substrate 810A, a gate driving circuit 812, and multiple pixel circuits Pa(1, 1) to Pa(m, n). The light emitting unit 820 includes a substrate 820A, a gate driving circuit 822, and multiple pixel circuits Pb(1, 1) to Pb(m, n). The light emitting unit 830 includes a substrate 830A, a gate driving circuit 832, and multiple pixel circuits Pc(1, 1) to Pc(m, n). The light emitting unit 840 includes a substrate 840A, a gate driving circuit 842, and multiple pixel circuits Pd(1, 1) to Pd(m, n). In this embodiment, scan signal lines and emit scan lines of the light emitting units 810 to 840 may be configured in a manner of the embodiment shown in FIG. 7B, respectively, but the disclosure is not limited thereto. Configuration of scan signal lines and emit scan lines of the light emitting units 810 to 840 may also be configured in a manner of the embodiment of FIG. 7A or FIG. 7C.

In this embodiment, the gate driving circuits 812, 822, 832, and 842 may receive the same first clock signal CK1 and second clock signal CK2. The gate driving circuit 812 of the light emitting unit 810 is electrically connected to the pixel circuits Pa(1, 1) to Pa(m, n) and the gate driving circuit 832 of the light emitting unit 830. The gate driving circuit 832 is electrically connected to the pixel circuits Pc(1, 1) to Pc(m, n) and a gate driving circuit of a next stage light emitting unit (not shown). Specifically, the gate driving circuit 812 may receive a start pulse SP1 provided by the external system circuit, and the gate driving circuit 812 may generate a first scan signal SA1 and multiple second scan signals according to the start pulse SP1, the first clock signal CK1, and the second clock signal CK2. The gate driving circuit 812 may provide the first scan signal SA1 to the gate driving circuit 832, and the gate driving circuit 812 may provide multiple second scan signals to the pixel circuits Pa(1, 1) to Pa(m, n). The gate driving circuit 832 may generate multiple second scan signals to the pixel circuits Pb(1, 1) to Pb(m, n) according to the first scan signal SA1, the first clock signal CK1, and the second clock signal CK2. The gate driving circuit 832 may use the first scan signal SA1 provided by a previous stage gate driving circuit 812 as a start pulse SP3, and the gate driving circuit 832 may then output a first scan signal SA3 to a gate driving circuit of a next stage light emitting unit.

In this embodiment, the gate driving circuit 822 of the light emitting unit 820 is electrically connected to the pixel circuits Pb(1, 1) to Pb(m, n) and the gate driving circuit 842 of the light emitting unit 840. The gate driving circuit 842 is electrically connected to the pixel circuits Pc(1, 1) to Pc(m, n) and a gate driving circuit of a next stage light emitting unit (not shown). The gate driving circuit 822 may also receive a start pulse SP2 provided by the external system circuit, and the gate driving circuit 822 may generate a first scan signal SA2 and multiple second scan signals according to the start pulse SP2, the first clock signal CK1, and the second clock signal CK2. The gate driving circuit 822 may provide the first scan signal SA2 to the gate driving circuit 842, and the gate driving circuit 822 may provide multiple second scan signals to the pixel circuits Pb(1, 1) to Pb(m, n). The gate driving circuit 842 may generate multiple second scan signals to the pixel circuits Pb(1,1) to Pb(m, n) according to the first scan signal SA2, the first clock signal CK1, and the second clock signal CK2. The gate driving circuit 842 may use the first scan signal SA2 provided by a previous stage gate driving circuit 822 as a start pulse SP4, and the gate driving circuit 842 may then output a first scan signal SA4 to a gate driving circuit of a next stage light emitting unit.

Therefore, the light emitting device 800 of this embodiment may splice the light emitting units 810 to 840, and number of scan signals provided by the external system circuit and number of lines may be reduced or circuit configuration of the light emitting device 800 may be simplified by means of a first scan signal output from a gate driving circuit of a previous stage light emitting unit as a start pulse of a gate driving circuit of a present stage light emitting unit.

In summary, the light emitting unit of the light emitting device of the disclosure may use a scan signal output by a scan circuit of a previous stage light emitting unit as a start pulse of a scan circuit of a present stage light emitting unit. The scan circuit and the emit circuit of the light emitting unit of the disclosure may receive the same start pulse and/or clock signal, which may reduce overall number of signal lines or simplify overall circuit configuration.

Finally, it should be noted that the above embodiments are intended only to illustrate the technical solutions of the disclosure and not to limit them. Although the disclosure is described in detail with reference to the foregoing embodiments, it will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A light emitting device comprising:
a carrier;
a first light emitting unit disposed on the carrier and having a first scan circuit, a first emit circuit, a first input terminal, and a first output terminal; and
a second light emitting unit disposed on the carrier and having a second input terminal, wherein the second input terminal is electrically connected to the first output terminal of the first light emitting unit,
wherein the first scan circuit is configured to provide a first scan signal to the first emit circuit and the second light emitting unit.

2. The light emitting device according to claim 1, wherein the second light emitting unit has a second scan circuit and a second emit circuit, and the first scan circuit provides the first scan signal to the second emit circuit.

3. The light emitting device according to claim 1, wherein the first light emitting unit further comprises a first pixel circuit.

4. The light emitting device according to claim 3, wherein the first pixel circuit comprises a plurality of light emitting diodes with a plurality of colors.

5. The light emitting device according to claim 3, wherein the first pixel circuit comprises:
a first transistor, wherein a first terminal of the first transistor receives a data signal;
a second transistor, wherein a first terminal of the second transistor is electrically connected to a first voltage, and a control terminal of the second transistor is electrically connected to a second terminal of the first transistor;
a third transistor, wherein a first terminal of the third transistor is electrically connected to a second terminal of the second transistor, and a control terminal of the third transistor receives a first emit signal provided by the first emit circuit; and
a light emitting diode electrically connected to a second terminal of the third transistor.

6. The light emitting device according to claim 5, wherein the first transistor, the second transistor, and the third transistor are P-type transistors or N-type transistors, respectively.

7. The light emitting device according to claim 3, wherein the first light emitting unit further comprises a substrate, wherein the first scan circuit, the first emit circuit, and the first pixel circuit are disposed on the substrate, the substrate is disposed on the carrier, and the substrate is electrically connected to the carrier.

8. The light emitting device according to claim 3, wherein the first scan circuit comprises a plurality of scan units.

9. The light emitting device according to claim 8, wherein a part of the plurality of scan units is configured to generate a plurality of second scan signals provided to the first pixel circuit, and a last one of the plurality of scan units is configured to generate the first scan signal.

10. The light emitting device according to claim 8, wherein the plurality of scan units receive a same first clock signal and a same second clock signal.

11. The light emitting device according to claim 10, wherein the second clock signal is an inverted signal of the first clock signal.

12. The light emitting device according to claim 1, wherein the first scan circuit and the first emit circuit receive a same start pulse, a same first clock signal and a same second clock signal.

13. The light emitting device according to claim 12, wherein the second clock signal is an inverted signal of the first clock signal.

14. The light emitting device according to claim 1, wherein the light emitting device is a transparent display device.

15. The light emitting device according to claim 1, wherein the carrier comprises a pad and a line, wherein the first light emitting unit is electrically connected to the pad and the line.

16. The light emitting device according to claim 1, wherein the first light emitting unit further comprises a plurality of first pixel circuits, wherein the first scan circuit is electrically connected to at least one of the plurality of first pixel circuits, and the first emit circuit is electrically connected to the at least one of the plurality of first pixel circuits and the first scan circuit.

17. The light emitting device according to claim 1 further comprising:
a gate driving circuit comprising the first scan circuit and the first emit circuit,
wherein the first light emitting unit comprises a plurality of first pixel circuits, and the gate driving circuit drives the plurality of first pixel circuits.

18. The light emitting device according to claim 17, wherein the gate driving circuit provides a second scan signal and a first emit signal to the plurality of first pixel circuits.

19. The light emitting device according to claim 17, wherein the gate driving circuit provides a plurality of second scan signals and a plurality of first emit signals to the plurality of first pixel circuits.

20. The light emitting device according to claim 17, wherein the gate driving circuit provides a second scan signal and a plurality of first emit signals or a plurality of second scan signals and a first emit signal to the plurality of first pixel circuits.
